(19) United States
(12) Patent Application Publication
(10) Pub. No.: US 2018/0093127 A1
(43) Pub. Date: Apr. 5, 2018

(54) Tethered Physically-Therapeutic Apparatus with an Adjustable Flexible Cord

(71) Applicant: Mahesh Hinduja, Fremont, CA (US)

(72) Inventor: Mahesh Hinduja, Fremont, CA (US)

(21) Appl. No.: 15/725,257

(22) Filed: Oct. 4, 2017

Related U.S. Application Data
(60) Provisional application No. 62/403,896, filed on Oct. 4, 2016.

(51) Int. Cl. A63B 21/00; A63B 21/04; A63B 23/16; A63B 23/10; A63B 23/02; A63B 23/035; A61H 15/00

(52) U.S. Cl. CPC A63B 21/4025; A61H 2201/1695; A63B 21/00189; A63B 21/04; A63B 23/16; A63B 23/10; A63B 23/0233; A63B 23/0355; A61H 15/0092; A63B 2209/14; A61H 2015/0042; A61H 2201/0153; A61H 2201/0157; A61H 2201/0192; A61H 2201/1261; A61H 2201/1638; A61H 2201/1642; A61H 2201/165; A63B 21/0004

(57) ABSTRACT

A tethered physically-therapeutic apparatus with an adjustable flexible cord is capable of being latched onto the body of a user, whereby the user may exercise various skeletal muscles without the fear of dropping the physical-therapeutic apparatus. The tethered physically-therapeutic apparatus comprises a physically-therapeutic device, a bracing cord, and an adjustable clamp. The physically-therapeutic device can be used to exercise skeletal muscle in the hands or feet or massage the fascia of the body. The bracing cord is tied around the user's limb, which helps the user remain in control of the physically-therapeutic device. The adjustable clamp helps tighten the bracing cord around the user's limb, further securing the physically-therapeutic device to the user's body. A first cord end and a second cord end connects the bracing cord to the physically-therapeutic device. The adjustable clamp clamps the bracing cord at a first selected pinch point and a second selected pinch point.

The current application claims a priority to the U.S. Provisional Patent application Ser. No. 62/403,896 filed on Oct. 4, 2016.

### FIELD OF THE INVENTION

The present invention generally relates to tethered physically-therapeutic apparatus with an adjustable flexible cord. In particular, the present invention relates to a physically-therapeutic device capable of latching onto the limb of a user, thereby preventing the physically-therapeutic device from separating from the user's body.

### BACKGROUND OF THE INVENTION

Conventional squeezable exercise devices are used for a variety of reasons and afford a variety of emotional as well as physical benefits. Squeezing a squeezable exercise device has proven to relieve tension during stressful situations at work or school. Among the various psychological benefits associate with squeezable exercise device usage include but are not limited to tension release, stimulation of nerves, diversion from stressful thought, and improved mood. These are just some of the emotional and psychological benefits attributed to squeezable exercise device use.

One of the best way to stay healthy is exercising. As such, squeezable exercise devices can also be used to exercise the various parts of the body. In particular, squeezable exercise devices are especially useful for resistance training small skeletal muscles such as those in the fingers, wrist, ankle, and toes. Resistance training involves using loads to provide resistance against muscular contraction which helps strengthen skeletal muscles. Using squeezable exercise devices to resistance train the skeletal muscles in the hands or feet improves muscular tone in those areas of the body and prevents injuries caused by repetitive motion. For example, repeatedly squeezing the device and holding it for a period of time, can improve wrist strength. Similarly, pinching the device between the thumb and a finger, and repeating this process with all of the fingers can improve finger strength. These are just some of the exercises enabled by squeezable exercise devices.

Given the various benefits of squeezable exercise devices, people are using squeezable exercise devices while performing their daily activities. However, using squeezable exercise devices during some of these activities may prove to be especially dangerous. For example, using a squeezable exercise device while walking a dog risks the danger of dropping the device and losing it. Likewise, using a squeezable exercise device while cooking risks dropping the device into a hot stove or pan, thereby irreparably damaging the device.

It is therefore an object of the present invention to introduce a squeezable exercise device with an adjustable flexible cord that allows the user to attach the squeezable exercise device to their limb and/or body to prevent the squeezable exercise device from separating from the user.

### BRIEF DESCRIPTION OF THE DRAWINGS

FIG. 1 illustrates the present invention hanging from the wrist of the user.

FIG. 2 shows a perspective view of the present invention not engaged to a user.

FIG. 3 shows another perspective view of the present invention with the second loop latched to the user's wrist.

FIG. 4 shows a front perspective view of the present invention with the second loop latched to the user's wrist.

FIG. 5 shows a top perspective view of the present invention with a toggle stopper as the adjustable clamp.

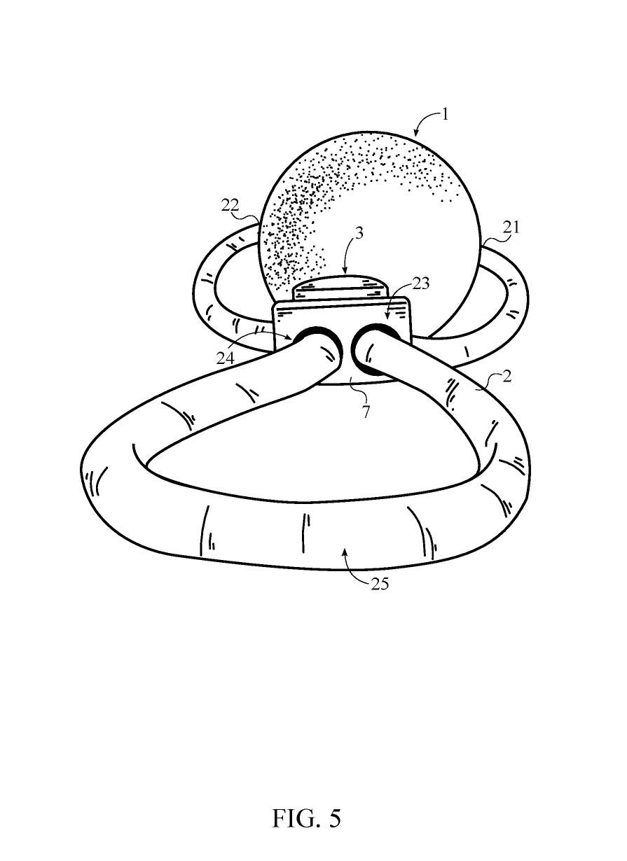

FIG. 6 shows a side perspective view of the present invention with the user's hand latched to the first loop.

FIG. 7 shows a front perspective view of the present invention with the user's hand latched to the first loop.

FIG. 8 shows a side perspective view of the present invention with the user's fingers latched to the first loop.

FIG. 9 shows a perspective view of the present invention with the physically-therapeutic device fashioned with a plurality of gripping knurls.

FIG. 10 shows a perspective view of the present invention with a physically-therapeutic device fashioned with a plurality of massaging protrusions.

### DETAILED DESCRIPTION OF THE INVENTION

All illustrations of the drawings are for the purpose of describing selected versions of the present invention and are not intended to limit the scope of the present invention.

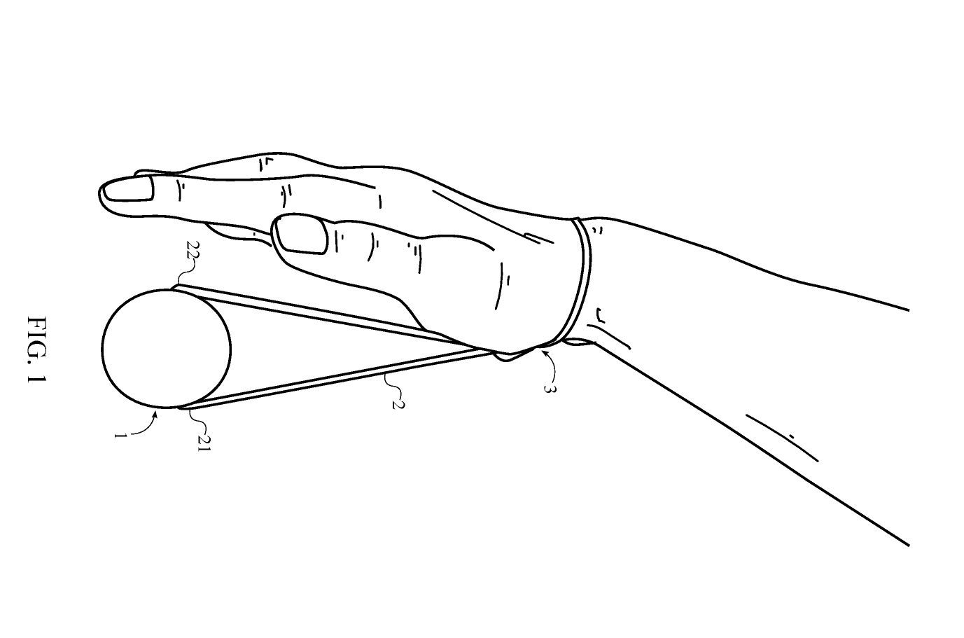

The present invention is a tethered physically-therapy apparatus used to exercise fingers, hand, arms, feet, legs, and back. FIG. 1 shows the preferred embodiment of the present invention. As such, the present invention comprises a physically-therapeutic device 1, a bracing cord 2, and an adjustable clamp 3. The physically-therapeutic device 1 is used to for resistance training joints on the fingers, hand, arms, feet, and legs. The physically-therapeutic device 1 is also used to perform myofascial release massage on the fascia of the human body. The bracing cord 2 selectively latches the physically-therapeutic device 1 to the user, thereby preventing the physically-therapeutic device 1 from separating from the user's body while in use. More specifically, the bracing cord 2 braces a limb of the user's body, thereby securely latching the physically-therapeutic device 1 to the user's body.

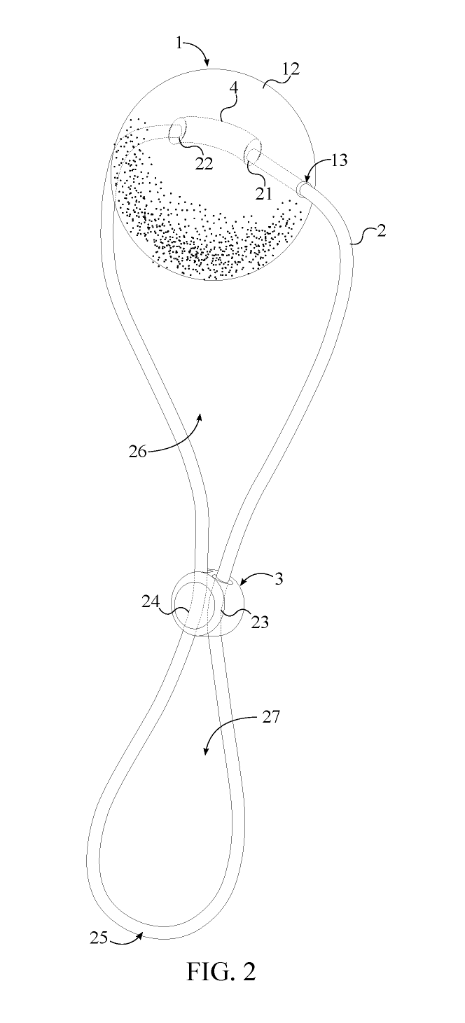

Referring now to FIG. 2, the bracing cord 2 comprises a first cord end 21, a second cord end 22, a first selected pinch point 23, and a second selected pinch point 24. The bracing cord 2 is affixed to the physically-therapeutic device 1 via the first cord end 21 and the second cord end 22. As such, the first cord end 21 and the second cord end 22 are tethered to the physically-therapeutic device 1. The first cord end 21 and the second cord end 22 may be tethered via variety of mechanical fastening mechanisms. For example, a chemical adhesive may be used to adhere the first cord end 21 and the second cord end 22 to the surface of the physically-therapeutic device 1. Alternately, the first cord end 21 and the second cord end 22 may be affixed to each other, thereby arranging the bracing cord 2 into a continuous loop that traverses within the physically-therapeutic device 1. The first cord end 21 and the second cord end 22 are positioned offset from each other about the physically-therapeutic device 1. This creates the space within the bracing cord 2. The first selected pinch point 23 and the second selected pinch point 24 are positioned in between the first cord end 21 and the second cord end 22 along the bracing cord 2. Alternately, the first cord end and the second cord end may be engaged on the exterior of the physically-therapeutic device 1. The adjustable clamp 3 clamps onto the bracing cord 2 at the first selected pinch point 23 and the second selected pinch point 24. Further, the first selected pinch point 23 and the second selected pinch point 24 are pressed against each other by the adjustable clamp 3 in order to form a first loop 26 and a second loop 27 with the bracing cord 2.

The bracing cord 2 further comprises a middle point 25. The middle point 25 may be designated as the most distal point in the second loop 27. As such the middle point 25 is positioned between the first selected pinch point 23 and the second selected pinch point 24 along the bracing cord 2. Further, the diameter of the second loop 27 may be designated as the distance between the middle point 25 and adjustable clamp 3. The first loop 26 of the bracing cord 2 is delineated between the first cord end 21, the first selected pinch point 23, the second selected pinch point 24, and the second cord end 22. This positions the physically-therapeutic device 1 along the circumference of the first loop 26. Likewise, the second loop 27 of the bracing cord 2 is delineated between the first selected pinch point 23, the middle point 25, and the second selected pinch point 24. Thus, the first loop 26 is positioned at one side of the adjustable clamp 3, and the second loop 27 is positioned at the opposite side of the adjustable clamp 3. This allows a circumferential length of the first loop 26 to be inversely proportional to a circumferential length of the second loop 27. In particular, sliding the adjustable clamp 3 along the bracing cord 2 farther away from the physically-therapeutic device 1 increases the circumference of the first loop 26 while decreasing the circumference of the second loop 27. Similarly, sliding the adjustable clamp 3 closer to the physically-therapeutic device 1 decreases the circumference of the first loop 26 while increasing the circumference of the second loop 27.

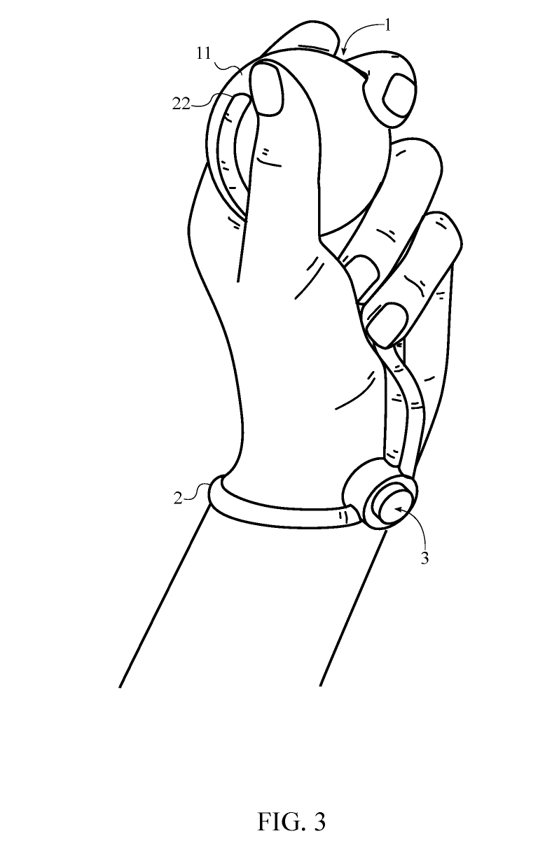

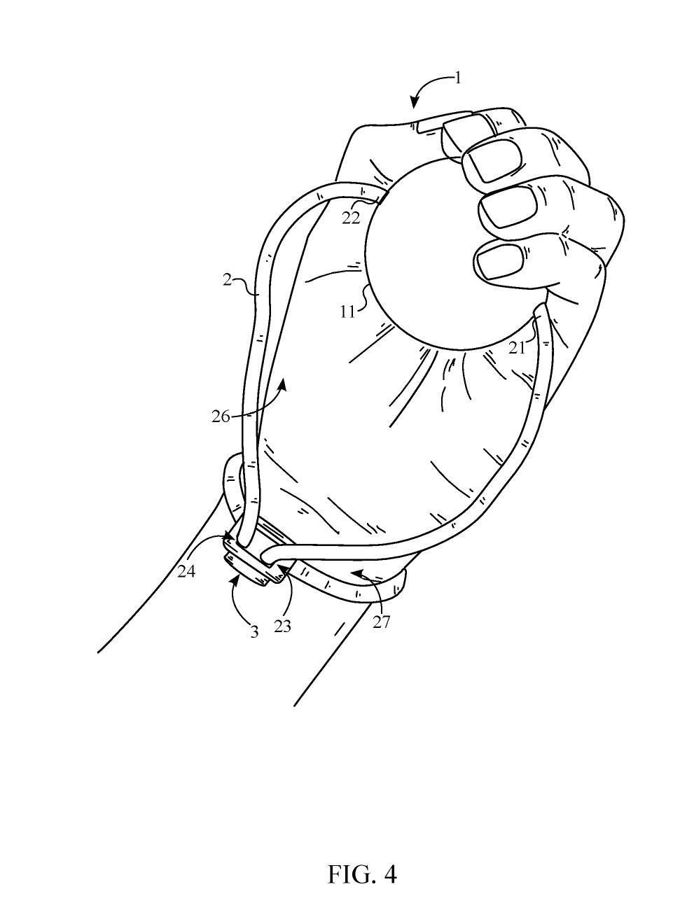

As can be seen in FIG. 3 and FIG. 4, in order to latch the physically-therapeutic device 1 to the body of the user, the user may insert a limb into the second loop 27. For example, in order to latch the physically-therapeutic device 1 to the arm, the hand is inserted into the second loop 27 and the adjustable clamp 3 is slid along the bracing cord 2 until the second loop 27 tightly constricts the wrist of the user. In this case, the first selected pinch point 23 and the second selected pinch point 24 are positioned next the wrist creases. Similarly, to attach the physically-therapeutic device 1 to the leg, the foot is inserted into the second loop 27 and tightened until the ankle is tightly constricted. In this case, the first selected pinch point 23 and the second selected pinch point 24 are positioned adjacent to the ankle of the user. The preferred adjustable clamp 3 is a toggle stopper 7. The toggle stopper 7 comprises a toggle, a housing, and a spring. The spring is mounted in between the toggle and the housing, wherein the spring pushes the toggle out of the housing. The first selected pinch point 23 and the second selected pinch point 24 are positioned between the toggle and the housing. As such, the spring pushes the toggle until the toggle constricts the first selected pinch point 23 and the second selected pinch point 24 against the housing. This prevents the adjustable fastener from sliding along the bracing cord 2, and affixes the circumference of the first loop 26 and the second loop 27. Pushing the toggle into the housing lifts the toggle off of the first selected pinch point 23 and the second selected pinch point 24, thereby allowing the adjustable fastener to freely slide along the bracing cord 2.

Referring back to FIG. 2, in the preferred embodiment of the present invention, a stopper 4 prevents the first cord end 21 and the second cord end 22 from being dislodged from the physically-therapeutic device 1. In order to receive the stopper 4, the physically-therapeutic device 1 comprises a structural body 12 and a cord-receiving hole 13. The cord-receiving hole 13 traverses through the structural body 12, thereby allowing the bracing cord 2 to form a continuous loop through the physically-therapeutic device 1. Further, the specific shape of the structural body 12 may be cylindrical, triangular, polygonal, spherical, or elliptical as required. The bracing cord 2 is positioned through the cord-receiving hole 13. In order to configure the bracing cord 2 into a continuous loop, the first cord end 21 and the second cord end 22 are fixed to each other by the stopper 4. Consequently, the stopper 4 is mounted within the cord-receiving hole 13. In the preferred embodiment, the stopper 4 are the first cord end 21 and the second cord end 22 glued together to effectively thicken the diameter of the bracing cord 2. As such the diameter of the bracing cord 2 is larger than the diameter of the cord-receiving hole 13, which causes the bracing cord 2 to rub against the cord-receiving hole 13. This creates a friction bond between the physically-therapeutic device 1 and the bracing cord 2.

Resistance training is among the various therapeutic functions enabled by the present invention. In particular, the present invention can be used to resistance train skeletal muscles and strengthen the joints of the body. As such, the physically-therapeutic device 1 is made of an elastically compressible material. More specifically, the physically-therapeutic device 1 is preferably made of a pliable polymeric material. Thus, as the user compresses the physically-therapeutic device 1 the amount of force experienced by the user also increases. This can be used to progressively increase the force output of muscle through incremental increases in the amount of force exerted by the physically-therapeutic device 1.

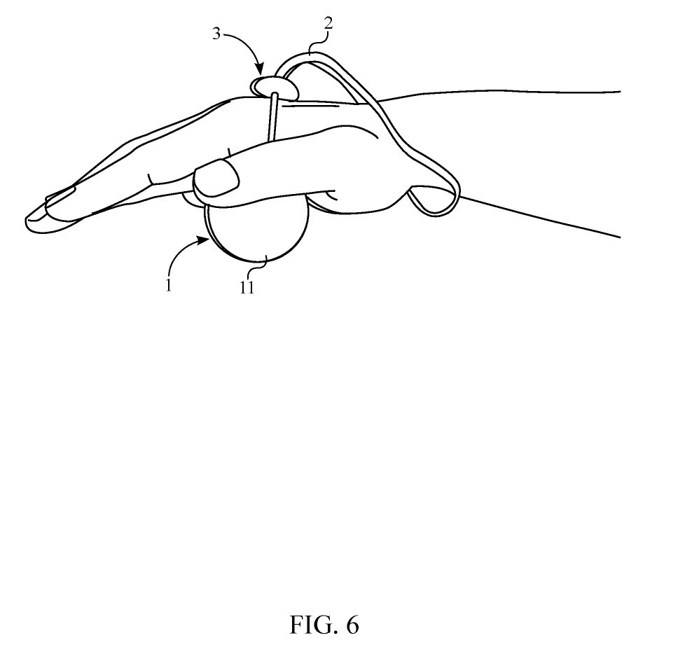

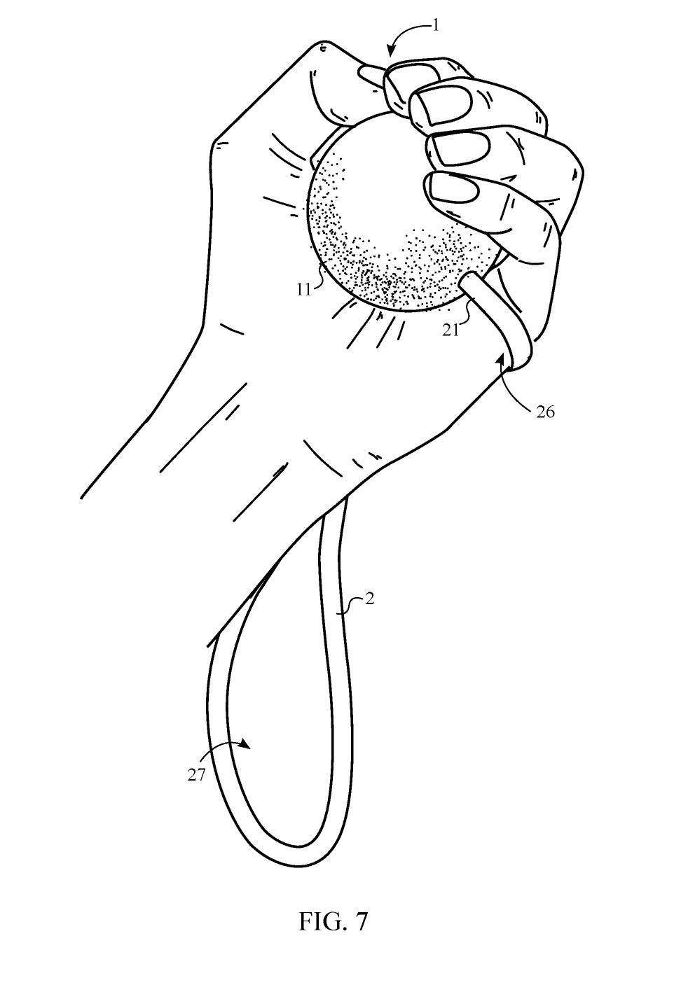

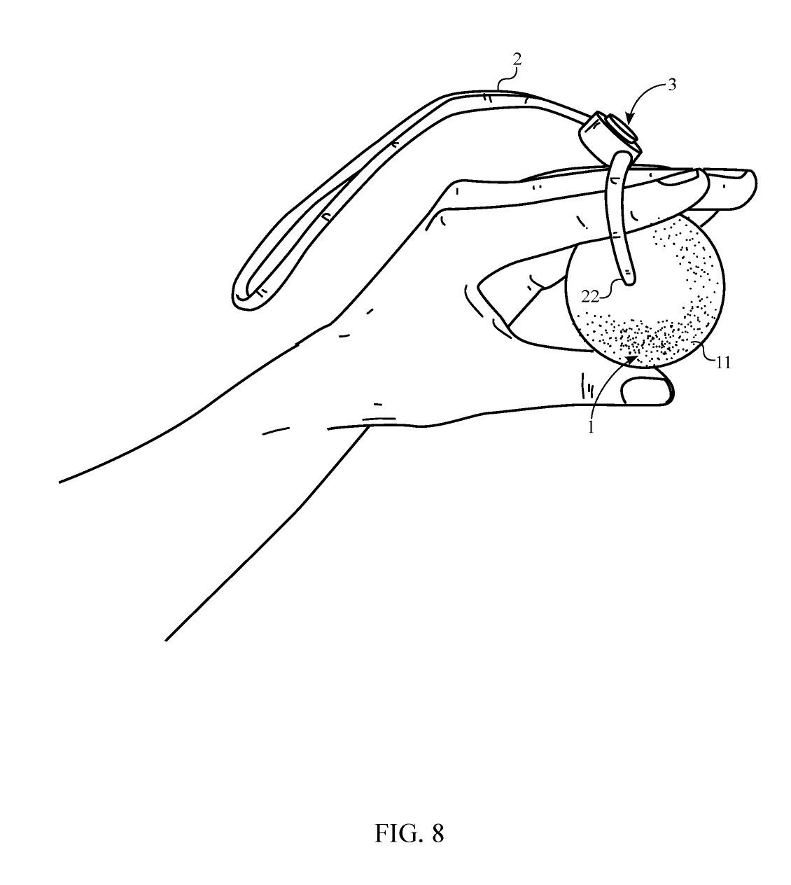

FIG. 6, FIG. 7, and FIG. 8 shows the preferred embodiment of the physically-therapeutic device 1 as a spherical body 11. The spherical body 11 facilitates various types of exercises that can be used to strengthen joints of the hands and legs. The first cord end 21 and the second cord end 22 are diametrically opposed to each other about the spherical body 11. This widens the diameter of the first loop 26 to accept the fingers, hands, wrist, foot, ankle, or legs of the user. This is particularly useful to conduct finger exercises. As such, the second loop 27 can also be used to latch the physically-therapeutic device 1 to the body.

The spherical body 11 and the compressible nature of the physically-therapeutic device 1 facilitates various types of resistance training exercises. Described below are some of strength training exercises for the hand:

### Power Grip:

Repeatedly squeeze spherical body 11 with fingers and thumb
Use fingertips to apply pressure to the spherical body 11

### Opposition:

Place spherical body 11 in the palm of the hand
Position the spherical body 11 between the thumb and finger being exercised
Repeatedly squeeze thumb and finger together

### Pinch:

Place spherical body 11 between any two fingers
Repeatedly squeeze together
   Side squeeze:
Place spherical body 11 between any two fingers and repeatedly squeeze together
   Arm squeeze:
Using two of the present inventions tethered to the palms, join hands together over the head
Repeatedly apply pressure, hold, and relax
   Grip strength:
Hold the spherical body 11 between the thumb and the forefinger and repeatedly squeeze gently

### Extend out:

Place the spherical body 11 on a table
Put tips of fingers on the spherical body 11
Repeatedly roll the spherical body 11 over the table

### Extend out (Version 2):

Place the spherical body 11 between the bent thumb and two fingers of the same hand
Repeatedly roll the spherical body 11, extend, and straighten the thumb
   Finger band:
Place the spherical body 11 in the palm of the hand with the fingers pressed into the surface
Squeeze, hold, and relax
   Back squeeze:
Using two of the present inventions tethered to the palms of separate hands, join the two hands in front of the chest
Make the spherical body 11 of each one of the present inventions touch each other
Repeatedly apply pressure, hold, and relax

In addition to the hand exercises described above, the present invention can also be used to resistance train the foot, by attach the bracing cord 2 to the user's leg.

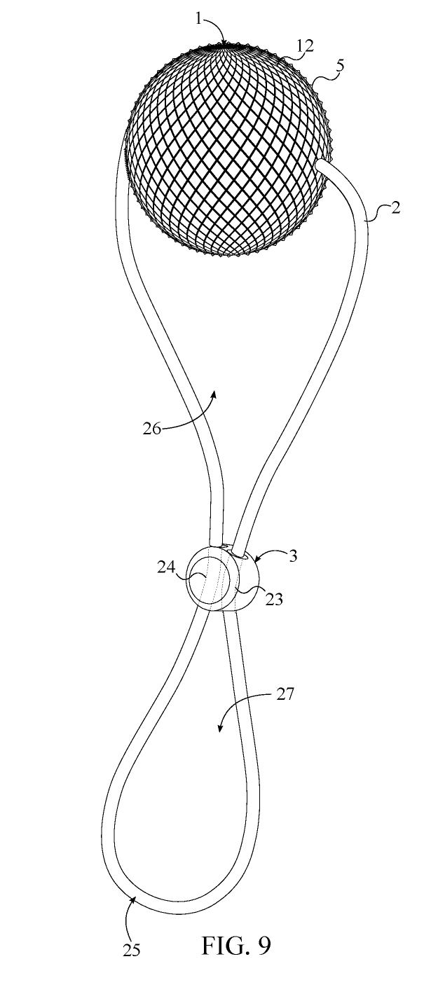

Referring to FIG. 9, to further aid the user to hold on to the physically-therapeutic device 1, a plurality of gripping knurls 5 is distributed over the surface of the physically-therapeutic device 1. More specifically, the plurality of gripping knurls 5 is externally connected on the physically-therapeutic device 1. The plurality of gripping knurls 5 clasps onto the user's skin thereby presenting a physical barrier that prevents the physically-therapeutic device 1 from slipping from the user's grip. The preferred plurality of gripping knurls 5 is miniature projection extruding perpendicularly out of the surface of the physically-therapeutic device 1.

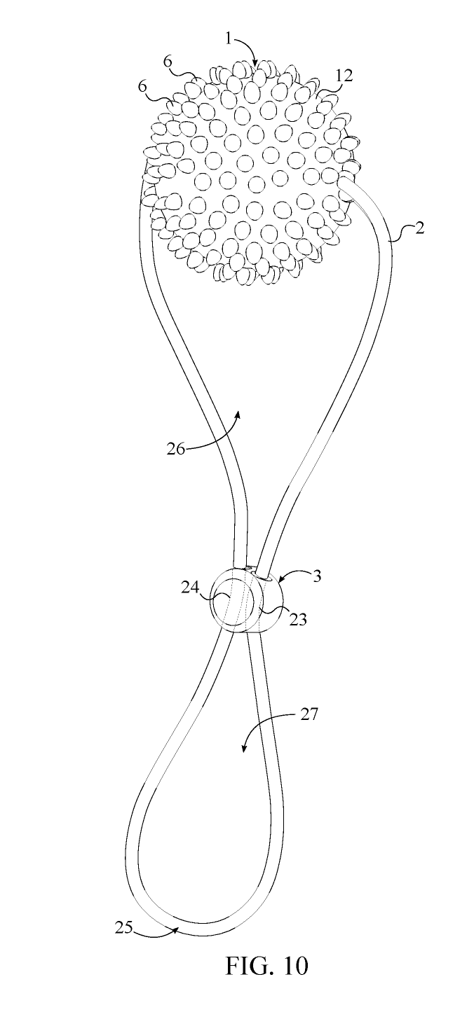

Referring to FIG. 10, in another embodiment of the present invention, the physically-therapeutic device 1 may be made of a rigid material. Preferably, the physically-therapeutic device 1 may be made of rubber, plastic, a thermoplastic rubber, silicone, or similar materials. A rigid physically-therapeutic device 1 performs myofascial release massage on the fascia of the human body. As such, the physically-therapeutic device 1 may comprise a plurality of massaging protrusions 6. The plurality of massaging protrusions 6 is externally connected onto the physically-therapeutic device 1. More specifically, the preferred plurality of massaging protrusions 6 is a conical protrusion extending perpendicularly out of the outer surface of the physically-therapeutic device 1. Alternately, the massaging protrusions may be formed out of deep ridges imprinted onto the outer surface. The plurality of massaging protrusions 6 is distributed about the physically-therapeutic device 1. Consequently, when the user applies pressure to the physically-therapeutic device 1, the plurality of massaging protrusions 6 presses into the fascia of the body, thereby inducing myofascial release of the body. This relax contracted muscle, stimulate blood and lymphatic circulation, and induce the stretch reflex in muscles. The plurality of massaging protrusions 6 can also be used for other massage therapies well known in the relevant arts.

Although the invention has been explained in relation to its preferred embodiment, it is to be understood that many other possible modifications and variations can be made without departing from the spirit and scope of the invention as hereinafter claimed.

What is claimed is:

1. A tethered physical-therapy apparatus comprises:
a physically-therapeutic device;
a bracing cord;
an adjustable clamp;
the bracing cord comprises a first cord end, a second cord end, a first selected pinch point, and a second selected pinch point;
the first cord end and the second cord end being tethered to the physically-therapeutic device;
the first selected pinch point and the second selected pinch point being positioned in between the first cord end and the second cord end along the bracing cord; and
the first selected pinch point and the second selected pinch point being pressed against each other by the adjustable clamp.

2. The tethered physical-therapy apparatus as claimed in claim 1 comprises:
the first cord end and the second cord end being positioned offset from each other about the physically-therapeutic device.

3. The tethered physical-therapy apparatus as claimed in claim 1 comprises:
the physically-therapeutic device being a spherical body; and
the first cord end and the second cord end being diametrically opposed to each other about the spherical body.

4. The tethered physical-therapy apparatus as claimed in claim 1 comprises:
a stopper;
the physically-therapeutic device comprises a structural body and a cord-receiving hole;
the cord-receiving hole traversing through the structural body;
the bracing cord being positioned through the cord-receiving hole;
the first cord end and the second cord end being fixed to each other by the stopper; and
the stopper being mounted within the cord-receiving hole.

5. The tethered physical-therapy apparatus as claimed in claim 1, wherein the physically-therapeutic device is made of an elastically compressible material.

6. The tethered physical-therapy apparatus as claimed in claim 6 comprises:
a plurality of gripping knurls;
the plurality of gripping knurls being externally connected onto the physically-therapeutic device; and
the plurality of gripping knurls being distributed about the physically-therapeutic device.

7. The tethered physical-therapy apparatus as claimed in claim 1, wherein the physically-therapeutic device is made of a rigid material.

8. The tethered physical-therapy apparatus as claimed in claim 7 comprises:
a plurality of massaging protrusions;
the plurality of massaging protrusions being externally connected onto the physically-therapeutic device; and
the plurality of massaging protrusions being distributed about the physically-therapeutic device.

9. The tethered physical-therapy apparatus as claimed in claim 1 comprises:
the bracing cord further comprises a middle point;
the middle point being positioned in between the first selected pinch point and the second selected pinch point along the bracing cord;
a first loop of the bracing cord being delineated between the first cord end, the first selected pinch point, the second selected pinch point, and the second cord end;
a second loop of the bracing cord being delineated between the first selected pinch point, the middle point, and the second selected pinch point; and
a circumferential length of the first loop being inversely proportional to a circumferential length of the second loop.

10. The tethered physical-therapy apparatus as claimed in claim 1, wherein the adjustable clamp is a toggle stopper.

11. A tethered physical-therapy apparatus comprises:
a physically-therapeutic device;
a bracing cord;
an adjustable clamp;
the bracing cord comprises a first cord end, a second cord end, a first selected pinch point, and a second selected pinch point;
the first cord end and the second cord end being tethered to the physically-therapeutic device;
the first cord end and the second cord end being positioned offset from each other about the physically-therapeutic device;
the first selected pinch point and the second selected pinch point being positioned in between the first cord end and the second cord end along the bracing cord;
the first selected pinch point and the second selected pinch point being pressed against each other by the adjustable clamp;
the physically-therapeutic device being a spherical body;
the first cord end and the second cord end being diametrically opposed to each other about the spherical body; and
wherein the physically-therapeutic device is made of an elastically compressible material.

12. The tethered physical-therapy apparatus as claimed in claim 11 comprises:
a stopper;
the physically-therapeutic device comprises a structural body and a cord-receiving hole;
the cord-receiving hole traversing through the structural body;
the bracing cord being positioned through the cord-receiving hole;
the first cord end and the second cord end being fixed to each other by the stopper; and
the stopper being mounted within the cord-receiving hole.

13. The tethered physical-therapy apparatus as claimed in claim 11 comprises:
a plurality of gripping knurls;
the plurality of gripping knurls being externally connected onto the physically-therapeutic device; and
the plurality of gripping knurls being distributed about the physically-therapeutic device.

14. The tethered physical-therapy apparatus as claimed in claim 11 comprises:
the bracing cord further comprises a middle point;
the middle point being positioned in between the first selected pinch point and the second selected pinch point along the bracing cord;
a first loop of the bracing cord being delineated between the first cord end, the first selected pinch point, the second selected pinch point, and the second cord end;
a second loop of the bracing cord being delineated between the first selected pinch point, the middle point, and the second selected pinch point; and
a circumferential length of the first loop being inversely proportional to a circumferential length of the second loop.

15. A tethered physical-therapy apparatus comprises:
a physically-therapeutic device;
a bracing cord;
an adjustable clamp;
the bracing cord comprises a first cord end, a second cord end, a first selected pinch point, and a second selected pinch point;
the first cord end and the second cord end being tethered to the physically-therapeutic device;
the first cord end and the second cord end being positioned offset from each other about the physically-therapeutic device;
the first selected pinch point and the second selected pinch point being positioned in between the first cord end and the second cord end along the bracing cord;
the first selected pinch point and the second selected pinch point being pressed against each other by the adjustable clamp; and
wherein the physically-therapeutic device is made of a rigid material.

16. The tethered physical-therapy apparatus as claimed in claim 15 comprises:
a plurality of massaging protrusions;
the plurality of massaging protrusions being externally connected onto the physically-therapeutic device; and
the plurality of massaging protrusions being distributed about the physically-therapeutic device.

17. The tethered physical-therapy apparatus as claimed in claim 15 comprises:
the bracing cord further comprises a middle point;
the middle point being positioned in between the first selected pinch point and the second selected pinch point along the bracing cord;
a first loop of the bracing cord being delineated between the first cord end, the first selected pinch point, the second selected pinch point, and the second cord end;
a second loop of the bracing cord being delineated between the first selected pinch point, the middle point, and the second selected pinch point; and
a circumferential length of the first loop being inversely proportional to a circumferential length of the second loop.

18. The tethered physical-therapy apparatus as claimed in claim 15, wherein the adjustable clamp is a toggle stopper.
